(19) United States
(12) Patent Application Publication
(10) Pub. No.: US 2009/0231346 A1
(43) Pub. Date: Sep. 17, 2009

(54) Diagnostic System for Visual Presentation, Animation and Sonification for Networks

(76) Inventors: Nalini Joshi Elkins, Carmel Valley, CA (US); William Jouris, Danville, CA (US); Stephen Lane Bryant, Charlotte, NC (US)

Correspondence Address: Nalini Elkins, 55 Piedras Blancas, Carmel Valley, CA, 93924, US

(21) Appl. No.: 12/137,262

(22) Filed: Jun. 11, 2008

Related U.S. Application Data
(63) Continuation-in-part of application No. 61/036,947, filed on Mar. 15, 2008, now abandoned.

(51) Int. Cl. G06T 13/00

(52) U.S. Cl. 345/473; 370/241

(57) ABSTRACT

A diagnostic system for visual representation, animation and sonification for networks that requires far less knowledge and can be used even by experts to reduce the time for analysis since it makes pattern analysis much more possible.

The screens to represent packet flow show icons which represent protocol elements and provide a context. Each network packet is parsed to assign it one or more functions, visual icons and sounds are assigned to such functions. Optionally, a written description may be shown with each functions.

The display of such packets may be shown in visual screens, animations and sonifications.

### RELATED APPLICATIONS

The present application is a continuation-in-part application of U.S. provisional patent application, Ser. No. 61/036,947, filed Mar. 15, 2008, for Diagnostic System for Visual Presentation, Animation, and Sonification for Networks, by Nalini Elkins, William Jouris, and Steven Bryant included by reference herein and for which benefit of the priority date is hereby claimed.

### FIELD OF THE INVENTION

The present invention relates to analysis of symbolic and numeric data and, more particularly, to such data occurring in a time series. Diagnosis of problems on communications network is an example of such data.

### BACKGROUND OF THE INVENTION

Analysis of complicated data which is the result of diagnostic tests is difficult to interpret. Such tests are used in many areas: communications networks (both data and voice), medicine, and finance. The tests may point to failures, or to problems of various types. In communications networks, timing failures, protocol failures, delays in transmission, jitter and other problems may occur.

The analysis of data from such tests is difficult because often a very large volume of data is produced as a result, but primarily because finding problems in such data requires a high level of expertise and the ability to find patterns. Please view FIG. 1 for a sample of a diagnostic trace in the current format.

Doctors spend many years to obtain the required education and, even so, specialize in particular areas. This same situation of long training and specialization also occurs with communications networks. Network diagnosticians specialize in routers, mainframes, LANs or other areas. Even after training, much hands-on experience is needed to become an expert.

One of the most common methods of finding difficult problems on communications networks is the packet trace. The trace is presented as a series of numbers, words and letters which symbolize each packet. A typical trace might contain information on thousands of such packets. Within a single packet, multiple protocols (IP, TCP, FTP, LDAP, UDP, etc.) may be used.

The amount of knowledge required to understand and find problems in a packet trace is considerable. Even in very large companies, the required knowledge is scarce. To find problems in a trace, the diagnostician must keep in mind the theory of the protocol as he/she searches for patterns or failures within the trace. Such problems can present as timing problems, malformed or duplicate packets, failures at an intermediate device, application problems, hardware problems, or many others.

In complex scenarios, a good diagnostician will find a bad pattern that is established, or a good pattern which is broken, to point him/her to the cause of the problem. Performance problems where an application (File Transfer, World Wide Web applications (HTTP), Telnet) or group of users on a subnetwork are having problems are particularly difficult. These problems can be intermittent, so that sometimes tests must be run repeatedly in order to find a problem.

Today, expertise is scarce. Time is at a premium. Diagnosing traces and finding problems can take hours, days, or even weeks. New protocols, such as IPv6 which changes the addressing structure or IPSec for security, are being introduced which add to the complexity of diagnostics. Any way possible to make interpreting the packet trace easier is a boon.

Today, some simple network problems can be found and fixed in the software which controls the routers or implements the protocols, but when the problems are difficult, it is a human being who must do the analysis. Expert systems have been tried, but the number of rules and associations which must be allowed for is so great that such systems have failed. Systems exist which provide recommendations for various types of failures but these lack the ability to present the data in a way which allows the diagnostician to recognize the pattern of data for which the recommendation may be valid or provide a recommendation for quite simple problems.

Heretofore, no method has been created to fulfill the need to allow a human diagnostician to quickly find patterns in a complex test such as a packet trace. The vicissitudes of global business interconnected by networks require an improved methodology for analysis.

Moreover, no current approach addresses the problem of lack of expertise in the many protocols that is required to properly analyze such a trace. In prior methods, the diagnostician must have all the knowledge when he/she looks at the results. Nor has any prior art addressed the combination of data presentation which shows the results with pattern matching and protocol significance in mind.

It would also be advantageous to provide a method of analysis that uses visual interpretation, such as pictures, in addition to the current numbers, letters or words which are used today. Such pictures can show the flow of traffic visually. This will greatly reduce the amount of expertise needed to interpret such traces. Current art shows, at most, some graphs to show when packets occur in a burst.

It would also be advantageous to provide an animation of the visuals. Then, one could see exactly how the user experienced the problem. Did he/she get two packets in a few milliseconds and then none for 4 seconds? Did errors occur in a burst? Such interpretation can be made by looking at the diagnostic traces, but it can be done much more quickly and for many more packets when it is shown in an animated sequence.

It would further be advantageous to provide a sonification of the packet flow. In complex scenarios, it has been shown that the human ear can distinguish patterns up to 10% more quickly and accurately than a visual display. In the new data and voice integration called Voice over IP (VoIP), being able to hear exactly the pattern of the conversation for a problem can be critical to resolution.

### SUMMARY OF THE INVENTION

The present invention provides a way to show a packet trace flow in visual symbols. This is a technology that we call the Visual Diagnostic Language (VDL). The VDL can be used for diagnosing and seeing the patterns for:
Normal data flow
TCP start up and shut down
TCP/UDP/ICMP/IPv6/ICMPv6 errors (dup acks, out of sequence, fragments, retransmissions, etc)
Application errors (FTP/HTTP/LDAP/MQSeries or any other TCP or UDP application)
Congestion window (routing and congestion problems)
Timing problems
   The packet trace shown in this way can also be animated and sonification added.

### BRIEF DESCRIPTION OF THE DRAWINGS

A complete understanding of the present invention may be obtained by reference to the accompanying screen images, when considered in conjunction with the subsequent, detailed description, in which:

FIG. 1 shows a packet in the original format;

FIG. 2 is a view of basic data flow to and from an IP address and port pair;

FIG. 3 shows how an interpacket timing value may be added to the basic data flow;

FIG. 4 shows how a remote and local receive congestion window may be added to basic data flow;

FIG. 5 shows how a significant protocol field may be added to basic data flow;

FIG. 6 shows how acknowledgment and sequence numbers for local and remote ends may be added to basic data flow;

FIG. 7 shows how error indicators may be added to basic data flow; and

FIG. 8 shows how transaction start, application processing end and transaction end indicators may be added to basic data flow;

FIG. 9 shows how animation and sonification may be done; and

FIG. 10 shows how the original packet in text format may be shown.

### DESCRIPTION OF THE PREFERRED EMBODIMENT

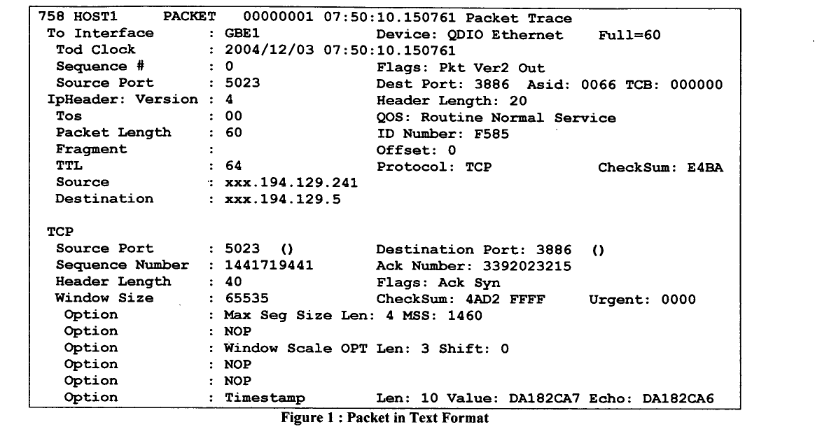

FIG. 1 shows a packet in the original format. Understanding the significance of this packet requires a good deal of knowledge. Seeing the pattern in the many such packets which comprise even a simple connection is clearly quite difficult.

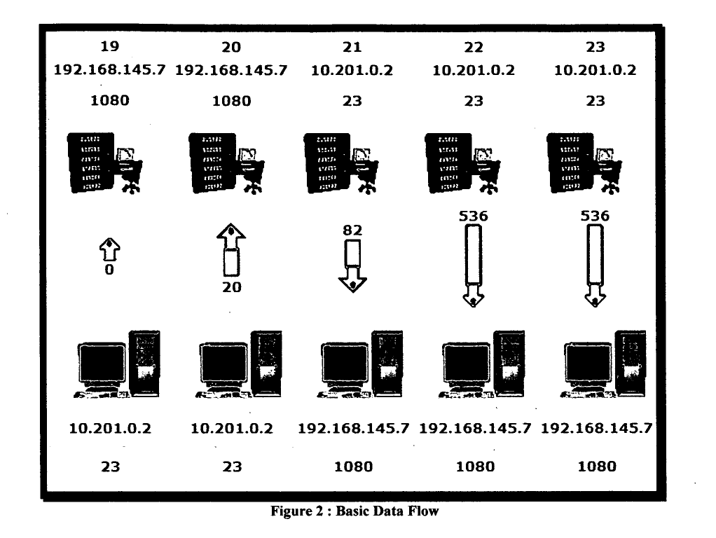

FIG. 2 is a view of basic data flow to and from an IP address and port pair. In this view, the packet trace is to and from a mainframe computer. The other side of the connection is a PC. The icons for mainframe and PC show how many bytes are sent to and from each direction. This makes it quite clear how and where the data is flowing.

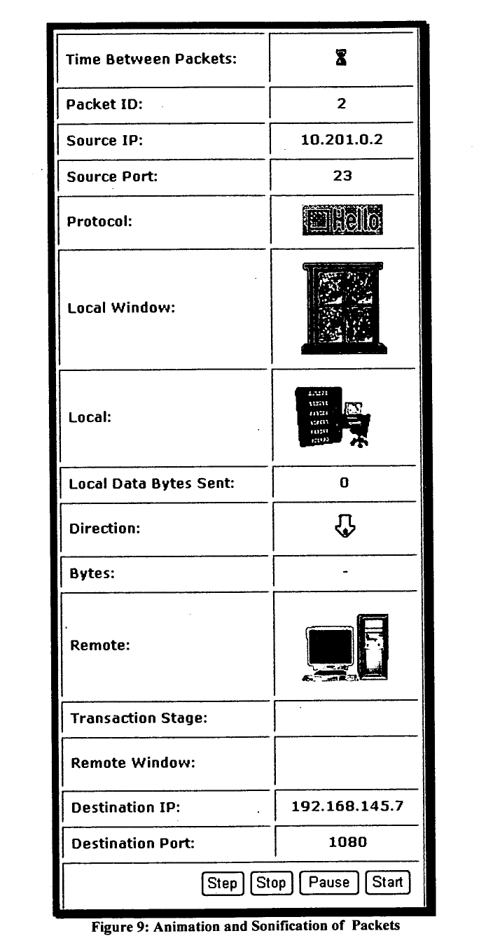

The byte counts shown are for the data. Each packet may contain additional bytes for the headers (TCP, IP, UDP, etc). This may be found by an investigation of the original packet (FIGS. 1 and 9). Additional screens may be created to show total byte flows as well as data flows.

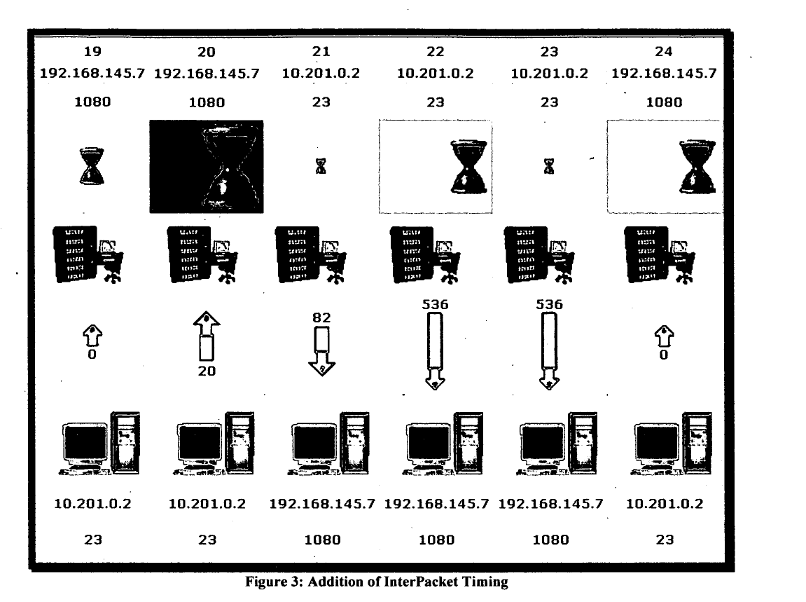

FIG. 3 shows how an interpacket timing value may be added to the basic data flow. The timing between packets is a critical portion of diagnosis. The timing is represented by an hourglass which will grow in size as the amount of time between packets becomes larger. It may be that one end of the connection is always slow. Then, the hourglass or other icon used may always appear as large when it is from that device.

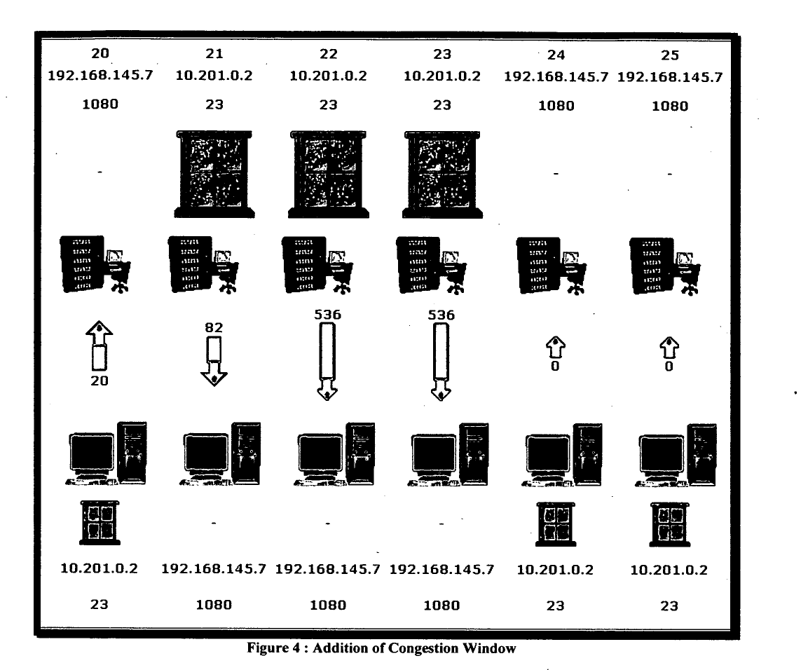

FIG. 4 show how a remote and local receive congestion window may be added to basic data flow. The congestion window signals to the sending device how much data may be sent before it must wait for an acknowledgement of the data. Waiting for acknowledgement introduces delay. Generally, the more data which can be sent without waiting, the greater the throughput and lower the time needed to send.

The congestion window is represented by an icon of a window which will grow or shrink in size as the window grows and shrinks. Windows of different colors may be used to represent to local and remote sides.

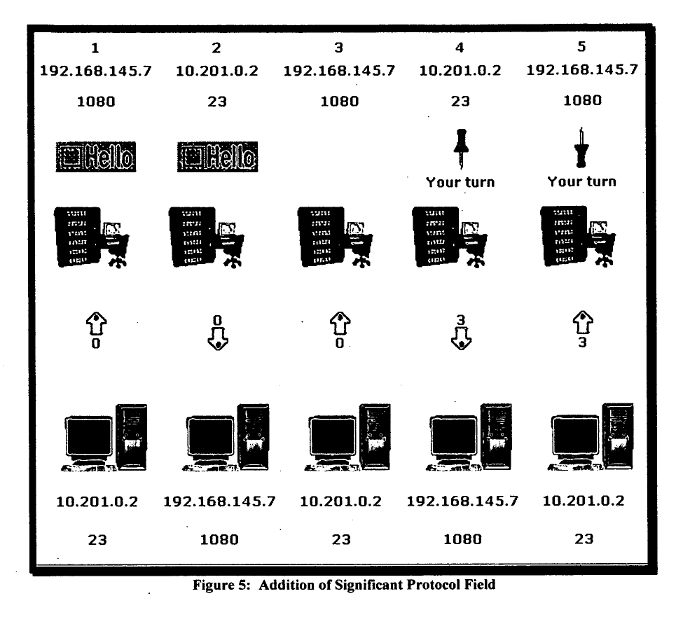

FIG. 5 shows how a significant protocol field may be added to basic data flow. Some data packets have a special significance in the protocol. For example, to start a TCP connection, a sequence of three (3) packets is sent with various bit settings in each. The conclusion of this sequence allows data transmission to start. This type of packet should be displayed with a representative icon. For example, the 3-way handshake to start the connection may be represented by icons such as ‘Ready’, ‘Set’, and ‘Go’. Missing any one of these packets would signal a problem. Such a display is intuitively obvious to most Western users.

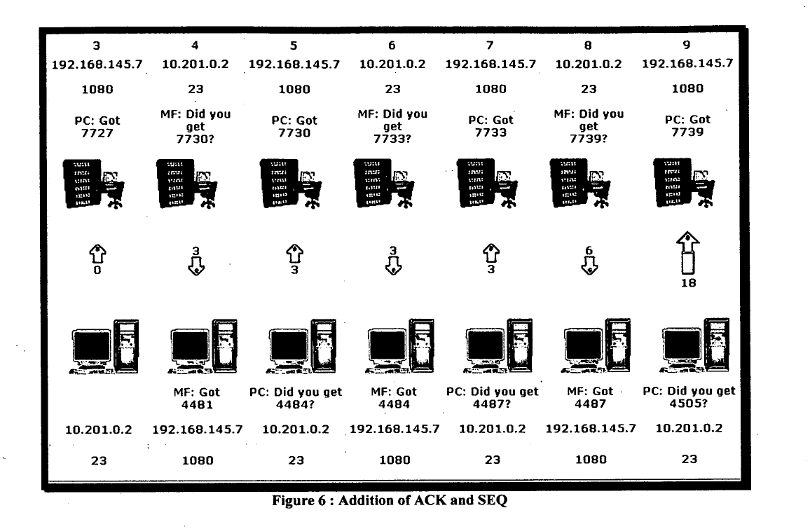

FIG. 6 shows how acknowledgment and sequence numbers for local and remote ends may be added to basic data flow. The sequence and acknowledgment numbers are used to signal the receipt of data and for error recovery. For example, if a packet is sent to a device with 100 bytes and a sequence number of 100, upon successful receipt, the device will return an acknowledgment number indicating the next byte it expects. In this case, an acknowledgment number of 101 would be returned. This means that the device has received up to 100 successfully and now expects to receive 101. Acknowledgment numbers are also used for error recovery. The same acknowledgment number may be sent multiple times to indicate a failure to receive a packet.

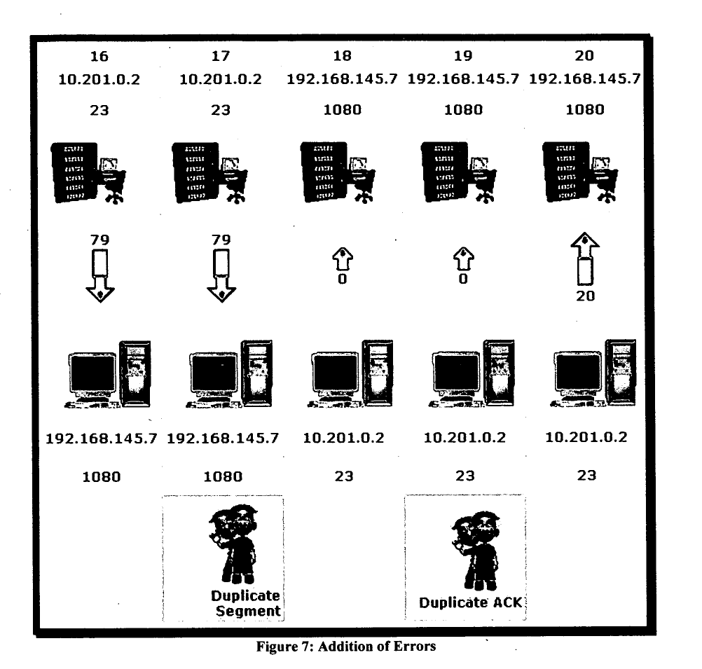

The packet flow can be full duplex. That is, both devices can be sending and receiving data at the same time. So, the sequence and acknowledgment numbers from both ends must be matched. The patterns to watch for are: failure to get the expected acknowledgment number, resends, or duplicate acknowledgment numbers. Some of these errors are also shown in FIG. 7.

FIG. 7 shows how error indicators may be added to basic data flow. Error indicators include the retransmissions discussed above, fragmentation and reassembly of packets, duplicate or out-or-order packets. Large gaps between packets are handled by the interpacket timing icons.

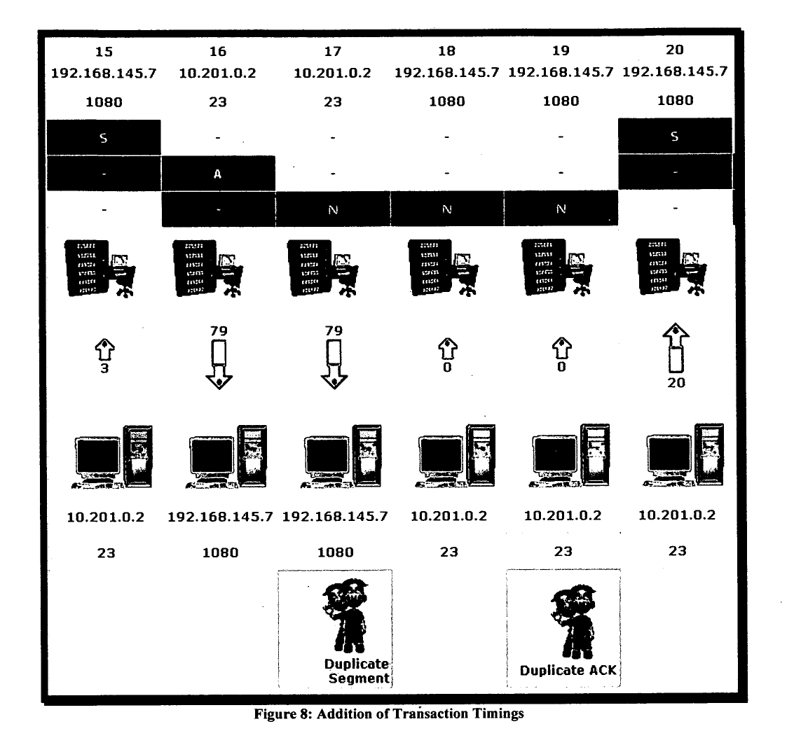

FIG. 8 shows how transaction start, application processing end and transaction end indicators may be added to basic data flow. Often, packets may be grouped into subsets that belong together. For example in a banking environment, packet 1 may be a user request for account balance, packet 2 may be the response with the number, and packet 3 the acknowledgment that the number was received. Such groupings are helpful in diagnosing response time problems which may be experienced by the user.

The transaction start, application processing end and transaction end indicators can also help to isolate the problem to the host application or to network components. When the error column is added to the above timing columns, as shown in FIG. 8, it becomes clear that excessive network time may be due to duplicate segments sent.

FIG. 9 shows how animation and sonification may be done. One may wish to view the packet flow to see the direction and timing of the packets. The animation should be done in accordance to the time flow the packets were received. That is, if the packets were sent in a rapid burst from one end and returned slowly from the other end, then this should be reflected in the animation.

Sonification adds an additional element in that now one may ‘hear’ the packets in the way they came in. The sounds can vary but send and receive should be associated with distinct tones or voices. Errors should be clear. For example, send may be a man's voice while receive is a woman's voice. Errors may be signaled by a cough. Thus, a session characterized by much coughing is likely to be problematic.

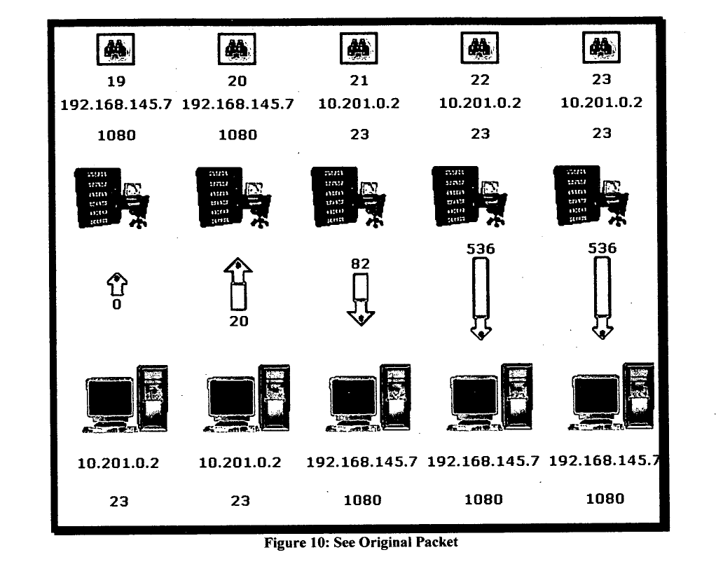

FIG. 10 shows how the original packet in text format may be shown. At times, the diagnostician may wish to view the original packet. This is especially true of experts who are used to seeing such packets. Being able to view the original packets also serves as a training tool for new diagnosticians.

Thus, in summary, it can be seen that what is provided in this invention is a diagnostic system for visual representation, animation and sonification for networks that requires far less knowledge and can be used even by experts to reduce the time for analysis since it makes pattern analysis much more possible.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A diagnostic system for visual representation, animation and sonification for networks, comprising:
An abstraction of a network packet to assign it one or more functions;
an assignment of visual icons to such functions;
an assignment of sounds to such functions;
an assignment of a written descriptions to the functions; and
the display of such packets in visual screens, animations and sonifications.
